(19) United States
(12) Patent Application Publication
(10) Pub. No.: US 2008/0173045 A1
(43) Pub. Date: Jul. 24, 2008

(54) Jewelry with precious and semi-precious materials

(76) Inventor: Carol Turner, Milwaukee, WI (US)

Correspondence Address: ABSOLUTE TECHNOLOGY LAW GROUP LLC, 135 W. WELLS ST., SUITE 518, MILWAUKEE, WI, 53203, US

(21) Appl. No.: 11/655,305

(22) Filed: Jan. 19, 2007

(51) Int. Cl. A44C 25/00; G09F 19/00; A44C 27/00

(52) U.S. Cl. 63/36; 40/406; 29/896.4

(57) ABSTRACT

An apparatus for use with jewelry comprised of: a back portion and a substantially clear front portion in which the back and front portions form a chamber therebetween and precious materials contained within the chamber. The substantially clear front portion allows the precious materials to be seen. The apparatus can further include end caps that match the precious materials, liquid within the chamber to suspend the precious materials, and be in the shape of a number or letter.

### FIELD OF THE INVENTION

This invention relates generally to the field of jewelry and in particular to the field of jewelry including a hollowed portion with precious materials contained therein.

### BRIEF DESCRIPTION OF THE DRAWINGS

FIG. 1 shows a front perspective view of one embodiment of the jewelry in the form of a pendant or charm.

FIG. 2a shows a cross-sectional view of the embodiment of the pendant or charm shown in FIG. 1 taken along line 2-2.

FIG. 2b shows a cross-sectional view of an alternate embodiment of the pendant or charm shown in FIG. 1 taken along line 2-2

FIG. 3 shows a front view of an alternate embodiment of the pendant or charm shown in FIG. 1.

FIG. 4 shows a front view of an alternate embodiment of the jewelry according to the instant invention in the form of a bracelet.

FIG. 5 shows a front view of an alternate embodiment of the jewelry according to the instant invention in the form of a pair of earrings.

### BACKGROUND

As defined herein, “jewelry” refers to any ornament or adornment, whether to be worn on a person, clothing, or elsewhere, including but not limited to necklaces, pendants, rings, earrings, watches, broaches, pins, body jewelry, cuff links, and combinations thereof, including articles for use with non-humans, e.g., on a dog leash or sweater, whether made of precious, semi-precious, or other metals, glass, plastic, or any other material commonly used in the art.

As used herein, the term “precious materials” refers to all stones, metals, and other materials commonly used for jewelry, including but non-limited to pearls, diamonds, rubies, amethysts, emeralds, topaz, or other birthstones and stones, minerals, and materials. In particular, “precious materials” includes metallic flakes, particles, pieces, or fragments of any precious or semi-precious metal (such as gold, silver, or platinum), any metallic alloy, or material designed to give the appearance of metal or metallic fragments. The term “precious materials” includes materials perceived as having an aesthetic value, regardless of whether or not they are classified by any industry as precious, semi-precious, or having a particular economic value.

### DETAILED DESCRIPTION OF EMBODIMENTS OF THE INVENTION

For the purpose of promoting an understanding of the present invention, references are made in the text hereof to embodiments of jewelry including a hollowed portion with precious materials contained therein, only some of which are depicted in the figures. It should nevertheless be understood that no limitations on the scope of the invention are thereby intended. One of ordinary skill in the art will readily appreciate that modifications such as the size and shape of the components, positioning of the components relative to one another, materials from which the apparatus is made, and the inclusion of additional elements are deemed readily apparent and obvious to one of ordinary skill in the art, and all equivalent relationships to those illustrated in the drawings and described in the written description do not depart from the spirit and scope of the present invention. Some of these possible modifications are mentioned in the following description. Therefore, specific details disclosed herein are not to be interpreted as limiting, but rather as a basis for the claims and as a representative basis for teaching one of ordinary skill in the art to employ the present invention in virtually any appropriately detailed system, structure, or manner. Moreover, in addition to jewelry, other embodiments of the invention such as ornamental or novelty items such as a key chain, a paper weight, a picture frame, a holiday ornament, or other items, are considered within the scope of the invention.

It should be understood that the drawings are not necessarily to scale, emphasis instead being placed upon illustrating the principles of the invention. In addition, in the embodiments depicted herein, like reference numerals refer to identical or nearly identical structural elements in the various drawings.

Moreover, the term “substantially” or “approximately” as used herein may be applied to modify any quantitative representation that could permissibly vary without resulting in a change in the basic function to which it is related. For example, one embodiment of a necklace pendant having a hollowed portion with precious materials contained therein is disclosed as having a hollow body. The body might permissibly be only partially hollow or include a chamber and still be within the scope of the invention if its functionality is not materially altered. Moreover, although reference is made to precious materials, it should be understood that any precious metals or semi-precious metals can be used which are capable of being adapted to achieve the appearance and function consistent with the embodiment described herein without departing from the spirit and scope of the invention.

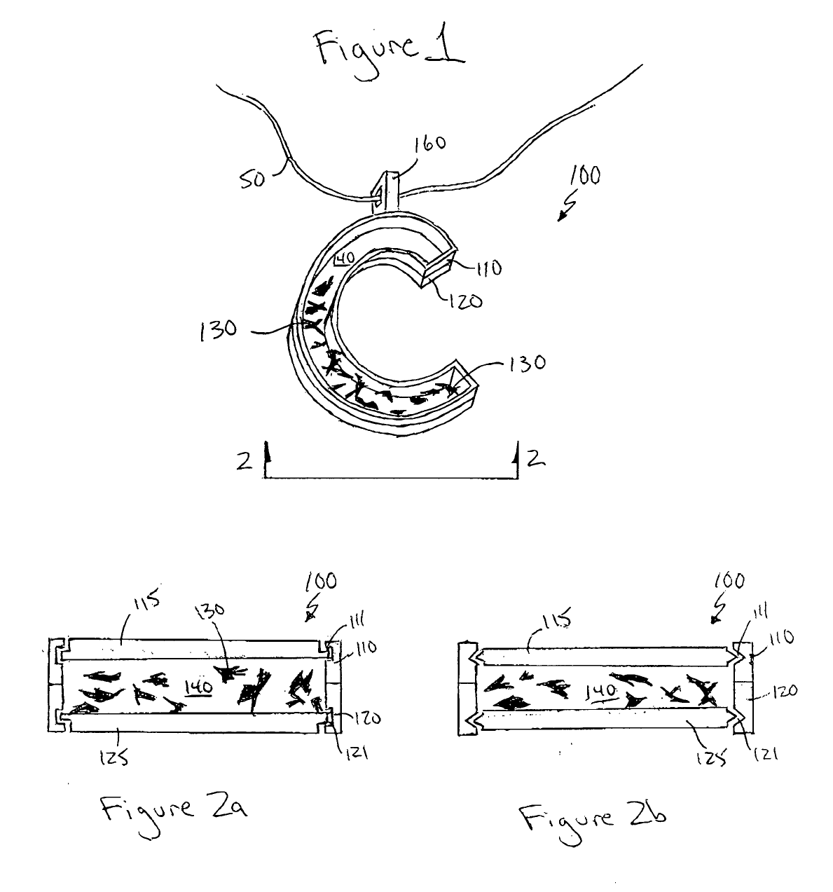

Referring now to the drawings, FIG. 1 shows a front perspective view of one embodiment of jewelry 100 in the form of a pendant. As can be seen, jewelry 100 is in the form of a letter, specifically the letter “C.” However, it should be understood that jewelry 100 can be in any letter, number, suggestive or fanciful image, symbol or other shape, e.g., a heart. In the embodiment shown, jewelry 100 further includes link 160 that allows jewelry 100 to be freely suspended from chain necklace 50. Jewelry 100 is constructed or formed such that precious materials 130 do not tarnish or escape from chamber 140 over time.

FIG. 2a shows a cross-sectional view of the embodiment of jewelry 100 shown in FIG. 1 taken along line 2-2. Front portion 110 having first groove 111, back portion 120 having second groove 121, front transparent member 115, back transparent member 125, precious materials 130, and chamber 140 can all be seen. In the embodiment shown, front portion 110 and back portion 120 are each made of molded metal in a shape which includes first groove 111 and second groove 121, respectively. Front transparent member 115 and back transparent member 125 are each inserted into first groove 111 and second groove 121, respectively, and front portion 110 and back portion 120 are affixed to each other. Front portion 110 and second portion 120 can be affixed to one another by any means commonly used in the art. In the embodiment shown, front portion 110 and second portion 120 are soldered to one another to form a substantially transparent chamber 140. In embodiments in which chamber 140 further contains a liquid contained therein (as described in detail infra), jewelry 100 is made of water-resistant materials and front portion 110 and second portion 120 must be affixed to one another such that jewelry is water-proof, i.e., to prevent the liquid from escaping chamber 140. Such an embodiment may necessitate the need for an epoxy (not shown) at the point where front transparent member engages first groove 111 on front portion 110 and at the point where back transparent member engages second groove 121 on back portion 120 to create the water-proofing.

In the embodiment shown, front transparent member 115 and back transparent member 125 are both made of a glass or other material which remains substantially transparent over time creating a substantially permanent transparent effect. However, front transparent member 115 can be made of any alternate clear or substantially clear material that allows precious materials 130 to be viewed, e.g., plastic, and may be colored or tinted.

As provided supra, in the embodiment shown, front portion 110 and back portion 120 are made of a metal, but can alternately be made of any other material commonly used in the art, whether clear, opaque, or partially clear. Furthermore, in the embodiment shown, front transparent member 115 and back transparent member 125 are both substantially clear. However, in an alternate embodiment, back transparent member 125 could be colored or substantially opaque to create an alternate effect. Similarly, back portion 120 could be constructed such that the back member and the back portion are one integrated component, making the second groove unnecessary.

FIG. 2b shows a cross-sectional view of an alternate embodiment of jewelry 100 shown in FIG. 1 taken along line 2-2. As with the embodiment shown in FIG. 2a, front portion 110, front transparent member 115, back portion 120, and back transparent member 125 form chamber 140 in which precious materials 130 are encased. However, in this embodiment, first groove 111 and second groove 121 are triangularly-shaped. In addition, front portion 110 extends forward of the forwardmost surface of front transparent member 115, and back portion 120 extends rearward of the rearmost surface of back transparent member 125. Whereas in the embodiment shown in FIG. 2a front transparent member 115 and back transparent member 125 are flush with front portion 110 and back portion 120, respectively, such a construction as shown in FIG. 2b forms a lip between front portion 110 and front transparent member 115 and between back portion 120 and back transparent member 125.

In addition, in both embodiments of jewelry 100 shown in FIGS. 2a and 2b, chamber 140 contains precious materials 130 partially suspended by and within a liquid, also contained in chamber 140. However, in alternate embodiments, chamber 140 is only filled with precious materials 130 and air or other gas.

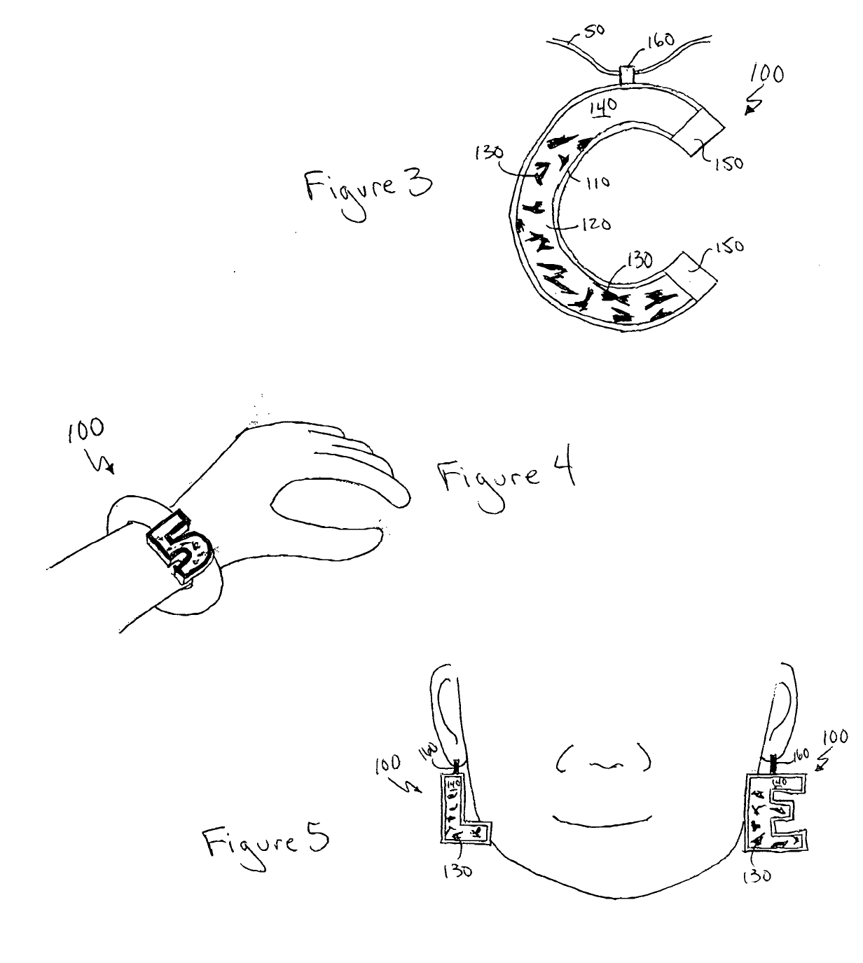

FIG. 3 shows a front view of an alternate embodiment of jewelry 100 shown in FIG. 1. As with the embodiment shown in FIGS. 2a and 2b, front portion 110 and back portion 120 form chamber 140 in which precious materials 130 are encased, and jewelry 100 is in the shape of a “C.” However, the embodiment of jewelry 100 shown in FIG. 3 further includes end caps 150. End caps 150 can be decorative and/or functional to close chamber 140. In the embodiment of jewelry 100 shown in FIG. 3, end caps 150 are dipped to match the color of precious materials 130, but can be of any color, style, or material commonly known in the art.

FIG. 4 shows a front view of an alternate embodiment of jewelry 100 according to the instant invention in the form of a bracelet. As with the embodiments described supra, jewelry 100 includes front portion 110, back portion 120, and chamber 140 in which precious materials 130 and a liquid are contained. This embodiment does not, however, include the end caps. As provided supra, jewelry 100 can be in the shape of a number. The embodiment of jewelry 100 shown in FIG. 4 is in the shape of the number “5.”

FIG. 5 shows a front view of an alternate embodiment of jewelry 100 according to the instant invention in the form of a pair of earrings. As with the embodiments described supra, jewelry 100 includes front portion 110, back portion 120, chamber 140 in which precious materials 130 and a liquid are contained, and end caps 150. As provided supra, jewelry 100 can be in the shape of alternate letters. The embodiment of jewelry 100 shown in FIG. 5 is in the shape of the letters “L” and “E.”

While the jewelry having a hollowed portion with precious materials contained therein has been shown and described with respect to several embodiments in accordance with the present invention, it is to be understood that the same is not limited thereto, but is susceptible to numerous changes and modifications as known to a person of ordinary skill in the art, and it is intended that the present invention not be limited to the details shown and described herein, but rather cover all such changes and modifications obvious to one of ordinary skill in the art.

What is claimed is:

1. An apparatus comprised of:
a back metal molded portion having a first groove;
a back transparent member fitted within said first groove of said back metal molded portion;
a front metal molded portion having a second groove and affixed to said back metal molded portion; and
a front transparent member fitted within said second groove of said front metal molded portion, said back metal molded portion, said back transparent member, said front metal molded portion, and said front transparent member forming a viewable chamber.

2. The apparatus of claim 1, further including a plurality of precious materials within said viewable chamber, said plurality of precious materials visible through said viewable chamber

3. The apparatus of claim 1, wherein said apparatus is an item selected from a group comprising jewelry, a key chain, a paper weight, a picture frame, a holiday ornament, an award, and combinations thereof.

4. The apparatus of claim 3, wherein said jewelry is selected from a group comprised of a necklace, a pendant, a ring, an earring, a nose ring, a watch, a broach, adornment for clothing or objects, a pin, body jewelry, a cuff link, and combinations thereof.

5. The apparatus of claim 1, wherein said apparatus is made in a shape selected from a group comprised of a letter, a symbol, and a number.

6. The apparatus of claim 1, wherein said viewable chamber is further at least partially filled with a substantially clear liquid.

7. A jewelry comprised of:
a back metal molded portion having a first groove;
a back transparent portion fitted within said first groove of said back metal molded portion;
a front metal molded portion having a second groove and affixed to said back metal molded portion;
a front transparent member fitted within said second groove of said front metal molded portion, said back metal molded portion, said back transparent member, said front metal molded portion, and said front transparent member forming a viewable chamber; and
a plurality of precious materials within said viewable chamber, said plurality of precious materials visible through said viewable chamber.

8. The jewelry of claim 7, wherein said jewelry is selected from a group comprised of a necklace, a pendant, a ring, an earring, a nose ring, a watch, a broach, adornment for clothing or objects, a pin, body jewelry, a cuff link, and combinations thereof.

9. The jewelry of claim 7, wherein said jewelry is made in a shape selected from a group comprised of a letter, a symbol, and a number.

10. The jewelry of claim 7, wherein said viewable chamber is further at least partially filled with a substantially clear liquid.

11. A necklace pendant comprised of:
a back portion;
a front portion;
at least one end cap, said back portion, said front portion, and said at least one end cap forming a chamber therebetween, wherein said front portion is substantially clear;
a substantially clear liquid at least partially filling said chamber; and
a plurality of precious materials within said chamber, said plurality of precious materials being viewable through said front portion.

12. The necklace pendant of claim 11, wherein said necklace pendant is made in a shape selected from a group comprised of a letter and a number.

13. The necklace pendant of claim 11, wherein said necklace pendant is further comprised of a link, said link allowing said necklace pendant to freely engage a necklace.

14. A method of making jewelry comprised of:
creating a back metal molded portion having a first groove;
fitting a back transparent member within said first groove of said back metal molded portion;
creating a front metal molded portion having a second groove;
fitting a front transparent member within said second groove of said front metal molded portion; and
affixing said back metal portion to said front metal portion to form a viewable chamber between said front molded and back molded portion.

15. The method of claim 14, wherein said method further includes a step of inserting a plurality of precious materials within said viewable chamber, said plurality of precious materials being visible through said viewable chamber.

16. The method of claim 14, wherein said viewable chamber further includes a step of at least partially filing said viewable chamber with a substantially clear liquid.
